(19) United States
(12) Patent Application Publication
(10) Pub. No.: US 2003/0094315 A1
(43) Pub. Date: May 22, 2003

(54) Solar powered transporter

(76) Inventor: Catherine White, Los Angeles, CA (US)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 09/990,058

(22) Filed: Nov. 20, 2001

(51) Int. Cl. B60L 9/00

(52) U.S. Cl. 180/2.2; 180/65.1

(57) ABSTRACT

A battery powered and portable transporter is especially suited for assisting the elderly by providing them with added mobility. The transporter is designed so the user can stand on its moving platform at about the same height as other pedestrians when being carried. Furthermore, the device can be folded into a configuration which can then be pulled along or even carried with ease when not in use. The transporter can be easily folded into compact form for storage in home, office or automobile.

### BACKGROUND OF THE INVENTION

1. Field of the Invention

This invention relates generally to stand-up personal transporter devices, and more particularly to such a personal transporter that is light weight and folds for easy storage and portability.

2. Description of Related Art

The following art defines the present state of this field:

Heilmann, U.S. Pat. No. 643,649 describes an electric-motor car with four motors, arranged in series diagonally two by two, so that one of the motors on the one side of the carriage is in series with one of the motors on the other side, and adapted to equalize the strains and pressure of the current in the two series of motors when the vehicle is turning a curve.

Timpson, U.S. Pat. No. 2,786,692 describes a collapsible utility cart comprising a U-shaped frame, a wheel supported axle, a flat plate secured to the extremity of each arm of said U-shaped frame and mounted on said axle in planes normal thereto and secured to said frame forward of said axle, said plates each being provided with circular ways which extend through substantially 90 degrees with a radial extension at the other extremity in a vertical plane passing through said axle when said frame is oriented as to tilt backward at a minor angle relative to vertical, plane passing through said axle when said frame is oriented a platform pivotally mounted on said axle intermediate the arms of said frame, a latching bar extending through said platform, resilient means for urging said latching bar toward said axle and into said radial extensions, whereby said platform may be latched in either of two positions oriented 90 degrees from each other where in one such position said platform is interleaved as to be approximately parallel with said frame.

Hilton, U.S. Pat. No. 3,229,782 describes a collapsible, three wheeled power vehicle comprising a forward single wheel frame driving the wheel thereof, a shaft extending vertically from the frame in combination with a steering means. A main longitudinal frame rotatably mounted on the vertical shaft and a horizontally disposed member secured to the longitudinal frame. A two wheel frame load mounted thereon, members extending vertically from the two wheel frame near the wheels and pivotally connected to the longitudinal frame, angularly disposed members mounted on the two wheel frame in combination with a detachable locking means alternatively supporting the horizontally disposed member of the longitudinal frame and securable above and against the steering means, where by the frames may be locked into a collapsed state and an open, supported state.

Weitzner, U.S. Pat. No. 3,314,494 describes a luggage scooter comprising a case bounded by a top wall, a front wall, a rear wall, side walls and a bottom end having and opening therein, a handle bar means pivotally secured to the top wall of the case. The case having a front opening and a rear opening wheel means secured to the bottom end. A platform means connected to one side of the bottom end with steerable caster wheels secured to the platform and a cover hingedly mounted on an edge of the front wall and adapted to enclose the front opening. A panel tiltably secured at the lower portion of the rear wall of the platform adapted to be positioned in a perpendicular relationship with the case. The panel is capable of being horizontally disposed upon the platform when the platform is in perpendicular relationship with the case and both the wheels of the case and the platform are providing riding means.

Alimanestiano, U.S. Pat. No. 3,446,304 describes a chassis mounted over a plurality of parallel rollers in combination with an endless belt mounted about the rollers having a ground bearing portion contacting the rollers and parallel to the platform and a plane passing through the centers of the rollers in combination with a driving gear, offset from the ground-bearing portion of the belt in driving engagement with the belt, the platform having walls depending from the platform and the rollers extend continuously between the walls and are mounted in bearings provided in the walls, including means for driving the gear and for steering the conveyor. The last said means including a handle extending vertically from the platform and laterally to one side thereof, the handle being pivoted from the vertical to a horizontally folded position parallel to and closely adjacent the platform.

Ostrow, U.S. Pat. No. 3,945,449 describes a generally rectangularly shaped support frame provided with ground-engaging wheels upon which almost any type and size of conventional chair may be readily mounted so as to provide mobile means for transporting non-ambulatory persons; certain of the ground engaging wheels are capable of being rotated manually by the person using the converted wheel chair in order to propel the chair in two embodiments of the invention, electrically in a third embodiment and selectively manually or electrically or both manually or electrically in a fourth embodiment thereof; a retractable foot rest is also incorporated in the support frame.

Winchell, U.S. Pat. No. 4,076,270 describes a cambering vehicle employing a cambering device which interconnects the trailing arms for controlled pivotal movement and includes means for locking the trailing arms together and for allowing the vehicle to be folded into a compact configuration so as to facilitate stowage thereof.

Patmont, U.S. Pat. No. 4,821,832 describes an improved light-weight, highly portable motor scooter having an elongated tubular frame which serves as muffler for a gasoline engine, a rear wheel secured to the frame at the rearward end thereof, a generally vertical, tubular support member secured to the frame at the forward end, a generally vertical strut member rotatably received within the tubular support member and having a yoke on the lower end thereof below the tubular support member, the yoke receiving a front wheel, a horizontal platform mounted on the frame, and engine secured to the frame adjacent the rearward end having a converter for coupling the engine to the rear wheel, an elongated handle member pivotally affixed at its lower end to the upper end of the strut member, the handle member being pivoted in a forward direction to pull the scooter and in a rearward direction to lie adjacent and parallel the frame whereby the scooter can be carried and extendable in an axially aligned position relative to the strut member and extendable over the upper end of the strut member to releasably lock the handle member and the strut member in the aligned position.

Bartley et al., U.S. Pat. No. 4,913,252 describes an article of motorized luggage is provided and consists of a plurality of wheels rotatably journaled to bottom of a container body for allowing travel along ground and a mechanism within the container body for driving one of the wheels to make the luggage a self powered unit. In a modification a steerable platform is connected to the luggage so as to transport a person standing upon the platform.

Andruet, U.S. Pat. No. 5,004,061 describes a motor vehicle including two wheel and axle sets, one in front and one in the rear, at least one of which is driven and at least one of which steers. The power to the vehicle is assured by an on-board source of electrical energy. Each wheel of each driven set is equipped with an electrical back-geared motor assembly supplied by the source of electrical energy, the motor assembly being connected to a chassis of the vehicle by two suspension triangles articulated on one side on the motor assembly and on another side on the chassis, the output shaft of the assembly including the axle of the corresponding wheel.

Rodenborn, U.S. Pat. No. 5,168,947 describes a motorized walker includes a base upon which a person can stand, with wheels on the base for rollably supporting the base. Variable speed reversible electric motors are provided for driving the wheels. A walker frame within which a person can stand is detachably mounted on the base, and includes control switches for separately and independently actuating the electric motors such that the person can stand on the motorized walker and maneuver it in any desired direction.

Patmont, U.S. Pat. No. 5,775,452 describes an electric powered scooter having a tubular frame extending between a front steerable wheel and a rear electrically powered wheel. The tubular frame extends below the wheel centers parallel to the surface of the ground between the front and rear wheels. A platform for the standing support of the scooter rider is mounted from frame mounted brackets so as to define between the upper portion of the tubular frame and the lower portion of the platform a spatial interval. Four batteries—with two on each side of the central frame member—are mounted to the underside of the platform which each battery supported by a case enclosing the battery at the bottom and mounting the battery flush to the underside of the platform at the top. An enclosed wiring channel is formed with the tubular frame at the bottom the batteries on either side, and the bottom of the platform at the top. The scooter design thus has the powering electric batteries mounted in a concealed under body position relative to the platform giving an electric scooter having a low center of gravity with optimal riding profile.

Edmondson, U.S. Pat. No. 5,921,338 describes a multiple wheel drive personal transporter including a lightweight skeletal frame based on a single cylindrical fore-aft beam to which front and rear axle, motor drive and wheel assemblies are connected. Each wheel is driven by a battery powered electrical motor and transmission gear sprocket chain drive. All wheels, or by user control option just front wheels, are powered on in parallel and energized by PWM drive circuitry. Throttle, forward/reverse, steering and other controls are available on a single flight stick. The seat is mounted over the beam near the rear, with front and rear battery trays and the user's weight distributed for optimum stability and traction and the beam is made of telescoped tubular sections incorporating a seat tilt limiting differential that responds to differential rotation of the front and rear wheel assemblies as the transporter traverses uneven ground.

The prior art teaches various designs in personal transport devices. However, the prior art does not teach that a light weight personal transport device may be constructed so that an upright handle may be folded downwardly to function as a pull handle when pulling the transporter behind when walking, and does not teach such a transporter with counter-rotatable forward wheels and caster rear wheels for control of steering function by simple motor control. The present invention fulfills these needs and provides further related advantages as described in the following summary.

### SUMMARY OF THE INVENTION

The present invention teaches certain benefits in construction and use which give rise to the objectives described below.

The present invention provides a solar powered and portable transporter. This transporter is especially suited for assisting the elderly by providing them with added mobility. The benefit of this invention over the prior art is that the transporter is designed so the user can stand on the transporter at about the same height as other pedestrians. Furthermore, the device can be folded into a configuration which can then be pulled along or even carried with ease when not in use; the transporter can be easily placed in cars or airplanes; and the transporter can otherwise accompany the user without burdening the user with a mobility means which is otherwise bulky, unwieldy, and burdensome.

In its simplest form, the transporter consists of a platform on wheels which is large enough to stand on but small enough to be portable and lightweight. The platform includes a plurality of wheels. A handle bar assembly is telescoping for height adjustment and folds flat against the platform. Plural storage batteries are electronically connected to an electric motor supported under the platform. The motor drives one or both of the wheels to provide propulsion and steering. A speed control, operated from the handle bar, provides control over the motor. Solar cells mounted on the platform and the handle bar assembly provide power to the storage batteries.

A primary objective of the present invention is to provide a solar powered personal transporter having advantages not taught by the prior art.

Another objective is to provide such a personal transporter being very light in weight so as to be easily carried or pulled behind when walking.

A further objective is to provide such a personal transporter that folds to accommodate compact portage and storage yet is strong enough to carry a grown person's weight and is able to move at walking speed.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a perspective view of a preferred embodiment of the present invention;

FIG. 2 is a plan view of the bottom thereof;

FIG. 3 is an electrical schematic diagram thereof.

### DETAILED DESCRIPTION OF THE INVENTION

The above described drawing figures illustrate the invention, a battery powered portable transporter 10 particularly suitable for elderly persons who need assistance in walking excessive distances. The transporter 10 consists of a platform 20 preferably having dimensions large enough to stand on, and made of a material that is rigid, durable, and light in weight. The platform 20 is preferably 14 inches long and 12 inches wide.

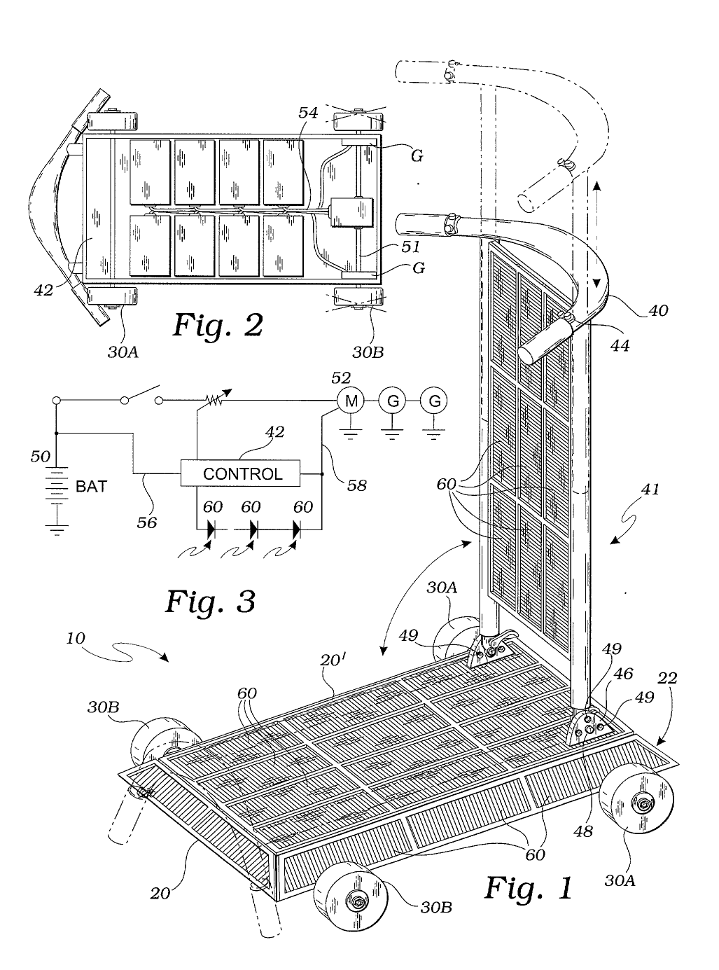

A plurality of wheels 30A, 30B are rotatably attached to the platform 20. The plurality of wheels preferably includes a pair of front wheels 30A and a pair of rear wheel means 30B. The front wheels 30A preferably are positioned close to the front end 22 of the platform 20, so the transporter 10 can be rolled in a folded position, as described below. The pair of rear wheels 30B are preferably located beneath or to the side of the platform 20, as shown in FIG. 1, so they do not interfere with the rider's feet while standing on the platform 20. Preferably, the rear wheels 30A are electrically gimbled so as to steer the invention.

As shown in the schematic diagram of FIG. 3, a battery 50 (BAT) is electrically connected, preferably with insulated power cables 54, to at least one electric motor 52. In its preferred embodiment, the battery 50 is a rechargeable nickel-cadmium type or equivalent, and is attached to the underside of the platform 20 with any common fastening means well known in the art. The electric drive of the invention may use two electric motors, one located next to each of the pair of front wheel 30A. As shown in FIG. 2, the electric motor 52 is mechanically engaged for driving, to wheels 30A by shafts 51.

A handle bar assembly 41 is preferably a collapsible telescoping structure as shown in FIG. 1, and is also pivotally attached to the front end 22 of the platform 20 with a pair of hinging brackets 46 and hinging bolts 48. Each hinging bracket 46 preferably has two or more locking bolt holes 49 which accept a locking bolt for locking the handle bar means 40 into either an upright, rearwardly folded or forwardly folded position. FIGS. 1&2 show the upright position which allows the user to ride the transporter 10. A control 42, as shown in FIG. 2, provides the user with control over the direction in which the transporter 10 moves as well as the speed at which it moves. The control 42 is electronically connected with the battery 50 with a first wire 56 and electronically connected to the motor 52 with a second wire 58, and provides the rider with control over the motor 52 as well as gimbles G shown in FIGS. 2 and 3. The control 42 preferably includes a computer control so as to be able to provide current regulation and control of gimbals G. In the preferred embodiment, the control 42 either starts or stops the motor means 52, providing only two speeds; however, a variable control providing a plurality of speeds is also possible within the scope of the invention. The handle bar 40 includes a steering means 44 preferably electrical signals controlled by buttons and which result in electric gimbal steering through gimbals G which may be simple electrically operated solenoids or other servo element. In FIG. 2, it can be seen that wheels 30B are able to change direction through gimbals G.

In use, the user simply stands on the platform means 20 and guides the transporter 10 to the desired destination at a selected speed. When the transporter 10 is not needed, the platform 20 is pivoted 90 degrees with respect to the position shown in FIG. 1, i.e., laid-down onto the platform 20. The locking bolt 49 then locks into the hinging bracket 46 to maintain the platform 20 in this position. Then, the handle bar 40 is collapsed, preferably through telescoping the handle bar 39. From this position the entire transporter 10 may be rested on the pair of front wheel means 30A. The user may easily pull the transporter 10 rolling behind, or is easily stored in the trunk of a car or an overhead space in an airplane or other storage means. See the phantom lines shown in FIG. 1 which clearly shows the position of the handle bar 40 when the assembly is folded. This folded position, with the handle bar 40 placed as shown, is an advance in this field and provides particularly convenient enablement for pulling the invention or pushing it. This bar configuration and folded position is considered particularly novel.

Solar panels 60 are positioned on the platform 20, on the handlebar assembly 41 and especially on side edges of the platform 20 which are positioned at a 45 degree angle to the platform top surface 20′. These panels are electrically interconnected in series-parallel circuits to achieve the necessary voltage for recharging battery 50 through a recharging circuit which is part of the control 42. The solar panels 60 are also wired to drive motor 52 and gimbals G directly. It has been discovered that the 45 degree angle of the lateral panels provides an improved reception of light, both direct sun light and indirect but still strong sky reflection. This has proven to make the difference between a practically operational invention and one that is too severely underpowered.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. An apparatus comprising: a platform having dimensions for fully supporting a rider; a plurality of wheels rotatably attached to the platform for supporting the platform in rolling motion on a supporting surface, the plurality of wheels comprising a pair of front wheels and a pair of rear wheels; a plurality of batteries mounted under the platform and electrically interconnected with a motor adapted for driving the front wheels; a telescoping handle bar assembly, attached to the platform and hingable thereon enabling movement from an upright position to a lowered position generally laying against an upfacing horizontal surface of the platform; a plurality of solar cells on the upfacing surface of the platform, on the handle bar assembly and on lateral edges of the platform disposed at an approximately 45 degree angle to the horizontal surface, the solar cells electrically interconnected through a control circuit for charging the batteries.

2. The apparatus of claim 1 further comprising a means for control of the velocity at which the transporter moves.

3. The apparatus of claim 1 wherein the handle bar assembly includes a pair of spaced apart tubes and a further pair of spaced apart rods engaged for linear telescoping motion within the pair of tubes respectively, and a handle bar engaged with the pair of rods, the rods and tubes frictionally engaged for positioning the handle bar at a desired height above the platform when the handle bar assembly is in the upright position.

4. The apparatus of claim 1 further providing a pair of electric steering gimbals positioned and mounted for enabling the rear wheels to steer the apparatus.

5. The apparatus of claim 1 wherein the handle bar assembly is foldable to a position wherein the handles protrude below the platform.
